(19) United States
(12) Patent Application Publication
(10) Pub. No.: US 2022/0269309 A1
(43) Pub. Date: Aug. 25, 2022

(54) COMPUTER-IMPLEMENTED SYSTEM AND METHOD FOR ASSISTING INPUT TO A VIRTUAL KEYPAD OR KEYBOARD ON AN ELECTRONIC DEVICE

(71) Applicants: LICENTIA GROUP LIMITED, Cardiff, South Glamorgan (GB); MYPINPAD LIMITED, Cardiff, South Glamorgan (GB)

(72) Inventor: Justin Pike, Blackwood, Gwent (GB)

(21) Appl. No.: 17/629,690

(22) PCT Filed: Jul. 27, 2020
(86) PCT No.: PCT/GB2020/051804

§ 371 Date: Jan. 24, 2022

(30) Foreign Application Priority Data
Jul. 25, 2019 (GB) 1910621.0

(51) Int. Cl. G06F 1/16; G06F 3/039; G06F 3/04886

(52) U.S. Cl. CPC G06F 1/1643; G06F 3/0393; G06F 3/04886; G06F 2203/04809

(57) ABSTRACT

The invention provides systems, devices and methods for improved guidance or assistance of data input into a touch screen enabled device such as a mobile phone, tablet, payment terminal etc. The invention is particularly beneficial for use in situations where visual observation of the screen is impaired or not possible, either because of a user's disability or environmental factors. One aspect the disclosure provides a data input assistance device comprising: a body for placement adjacent to a touch screen of an electronic device; at least one input zone provided in the body and arranged to facilitate a user to operate an area of the touch screen via contact with a surface of the screen; and at least one location indicator arranged to communicate, to a software component associated with the electronic device, the location of the input assistance device relative to the touch screen. The invention enables the provision of a virtual input arrangement such as a virtual pinpad, keyboard or keypad, at a location specified by a user. It also enables movement of the virtual input arrangement during use.

### TECHNICAL FIELD

This invention relates generally to techniques and devices for assisting data input by a user into an electronic device, and more particularly to facilitating, assisting and/or enabling data via a touch screen which is, preferably, provided in or on a mobile or portable electronic device. In a preferred embodiment, the data entry is performed by via an electronic, virtual keyboard/keypad provided in conjunction with the touch screen. The invention is particularly suited, but not limited to, use in facilitating data entry by disabled individuals such as the visually impaired or for use in poorly lit environments. It is also suited for, but not limited to, applications wherein authentication of a user is required before allowing access to a controlled resource.

### BACKGROUND

Virtual keypads have been known for some as data input mechanisms in respect of electronic devices, typically in conjunction with a touch screen. In use, a representation of the keypad is presented within an input zone (also called a “display zone”) of the screen, and the user selects a desired input (typically a key with an associated symbol or indicia) by touching the relevant portion of the screen. The touch may be with a finger or body part, or a touching device for conveying the user's input selection if the user is physically impaired or disabled in some way. Either way, direct contact is made by the user with the screen. The input zone of the screen is divided up hot spots, each having a sensor placed below it, so that the user's contact can be detected.

However, certain application or user-related constraints may pose challenges for the use of virtual keypads.

“SLAP widgets”, Association for Computing Machinery [2009], Malte, Weiss et al, pages 481-490 teaches the use of a camera to input data into a rear projection, multi-touch tabletop interface via a silicone or acrylic device such as a keyboard or slider. Reflective markers are provided on the device to generate a “footprint” and enable detection by the camera so that the position of the device can be tracked. Similarly, the Touchplates arrangement of Kane, S. K. et al “Touchplates: low-cost tactile overlays for visually impaired touch screen users”. In: Proceedings of the 15th International ACM SIGACCESS Conference on Computers and Accessibility, p. 22. ACM (2013) uses unpowered, acrylic plastic overlays that include visual tags. The tags can be recognised as optical markers by large, imaging touchscreens such as Microsoft surface table. In use, the blind user feels for and locates the visual tag on the device and uses it to orient the acrylic guide on the screen. However, while the Touchplate device is designed for use with large, tabletop touchscreens which utilise imaging technologies it would not be operable with capacitive touchscreens such as those commonly deployed in widespread use.

U.S. Pat. No. 9,965,116 teaches a tactile overlay for a touchscreen device which includes capacitive-sensing touch buttons that lie over soft buttons on a touch screen. When a change in capacitance is induced by a finger or other object having a capacitance that is different from air, this can be translated via a button capacitive component into a selection of a soft button underlying the touch button. Thus, there is a barrier, impediment or intermediate component between the user's touch and the screen which requires a translation to be made, communicating the user's input selection to the electronic device. This results in an arrangement that is complex and costly to manufacture. Similarly, US2011216015 discloses a removable graphic overlay which forms a passive keyboard. Physical, pressable keys contact the touch screen to perform the data entry.

Thus, it is desirable to provide an improved data entry assistance solution which facilitates, guides or enables the input of data by a user into an electronic device. Improvements provided by the solutions should ideally include: improved ease of use; improved efficiency of storage, transportation or manufacture, improved accuracy of identification or communication of desired inputs; reduced input errors due to improved identification/communication and therefore fewer processing resources required by the device as a result of handling erroneous inputs. Such an improved solution has now been devised which addresses at least these technical problems and provides at least these technical advantages.

### SUMMARY

In accordance with the present disclosure, devices, systems and methods are provided as defined in the appended claims.

In accordance with the disclosure there may be provided a device, a computer-implemented method and corresponding computer-implemented and system. The method/system/device may be referred to as a control method/system/device, a data input or input assistance method/system/device. It may be arranged or operative to guide, assist, facilitate and/or enable entry of data by a (human) user into an electronic device. The electronic device may be a computer-based device comprising one or more processors. The electronic device may comprise a secure storage element, such as a TEE. The virtual input component may be generated in, by or in association with the secure storage element. Any feature described below in relation to embodiments of the device may also be applicable to embodiments of the system and/or method, and vice versa, but may not be explicitly described as such for the sake of brevity and clarity only.

The disclosure comprises a device. This may be referred to as an overlay, location aid or guide, preferably for aiding the generation and/or tracking of a virtual input component such as a virtual keypad or keyboard etc. Additionally, or alternatively, it may be referred to as an input aid and/or a data input assistance device. The device is arranged to aid or facilitate entry of at least one input into an electronic device. Additionally, or alternatively, it may be referred to as a device for controlling or at least influencing the generation of virtual input arrangement/component on or in association with a touchscreen.

Preferably, the device is not fixed or connected to the electronic device. Preferably, it can move across the surface of the screen in use and/or be taken off or disconnected from the device when not in use. In a preferred embodiment, it is not fixed, adhered or maintained in position relative to the electronic device during or before/after use so that movement of the device across or relative to the screen can be tracked by software on the electronic device.

The device comprises a body. The body may be arranged for placement such that a portion (a leg or spacing mechanism) is adjacent to, close to, on or against a touch screen of the electronic device. It may be arranged for placement adjacent to etc a display zone of the touch screen. The touch screen may be associated with one or more sensors for detection of contact with the screen by a user.

The body also comprises at least one input zone arranged to facilitate or enable a user to operate, and/or send a signal to, an area of the touch screen by contact with the touch screen. The user may operate the touch screen via (e.g. through) the input zone of the device. The user may make contact with the touch screen. The user may make contact with the surface of the touch screen with a body part e.g. finger or a touching/pointing device (such as a stylus). This may be direct contact between the user and the screen, meaning that the device does not pose or provide an impediment to the user's contact either by their physical body or a conductive pointing device. The input zone may be spaced from the surface of the screen by one or more spacing mechanisms such as legs or protrusions (discussed below) which hold the body away from or not in contact with the surface of the screen.

The body also comprises at least one location indicator or element arranged to communicate a location to a software component associated with, or installed upon, the electronic device. The location may be the location of a portion of the input assistance device relative to the touch screen. The communication may be performed by transmission of a signal or energy derived from the user's body and/or as a results of contact between the device and the user's body. The location indicator may be arranged to hold or space the body or a portion thereof away from the touch screen, and/or may be provided on the body separately or as a different component from the at least one input zone. , The location indicators(s) may be the only portion of the input assistance device which makes contact with the screen. In another embodiment, one or more stabiliser(s) may also make contact with the screen.

Preferably, a region of the touch screen is and/or functions as a key of a virtual input component/arrangement. The virtual input component maybe a virtual keypad, a virtual pinpad or a virtual keyboard.

Thus, the device may function as a physical overlay which covers, at least in part, a virtual input component. The invention may use the location information provided/communicated by the location indicator(s) to control or influence the generation, movement, repositioning and/or provision of the virtual input component within a display zone of the touch screen.

At least a portion of the body may comprise a conductive material. It may be electroconductive material. It may be a material suitable for transmitting a signal or energy through the portion of the device body from the user to the screen. In one or more embodiments, the entire device or a substantial portion of it may be made of, or comprise, an electroconductive material. The body may be formed of a single layer of moulded conductive material.

The at least one input zone may comprise an aperture arranged to expose the screen. The aperture may be described as a “cut out”, “opening”, “recess” or “window”. It may enable direct contact of the touch screen by the user. The term “direct” includes the meaning that the user's body or a suitably arranged (e.g. conductive) input device such as a stylus or other pointing device physically touches or contacts the surface of the touchscreen. The user may contact the touch screen through or within the aperture.

In some embodiments, an electro conductive membrane or electro conductive portion of material may be provided within, over or approximate to the input zone. The input zone(s) may be arranged so as to be detectable by touch or audio communication. The zone(s) may be detectable without visual aid e.g. by a visually impaired user or in poorly lit environments. They may provide tactile and/or auditory feedback to the user to guide identification of the location and/or configuration of the input zone. For example, a user may be able to feel the edge of a window, or a ridge surrounding a window etc. Each input zone may be distinct from another input zone i.e. one or more or all of the input zones may be separated from each other, possibly by a portion of the body. The input zone(s) may be positioned and sized within the body to correspond to the position and size of the key(s) provided in the virtual input component. Thus, in use, the virtual input component may be provided by software on the electronic device such that the input zones overlie, align with and/or superimpose the virtual keys of the virtual input component.

The body may comprise a reference marker or guide for tactile or audible communication of a location on the body to a user via touch or sound. This may be arranged to enable a user to detect or identify a particular portion of the body. The reference marker may comprise a raised, indented or grooved portion relative to the body. Additionally, or alternatively, it may be arranged to communicate an audible signal to the user when the user touches or otherwise contacts the reference marker. Additionally, or alternatively, the size, shape or orientation of one or more input zones may be arranged or configured to serve as the reference marker. For example, the “5” key may be provided as a square cut out or opening while the other keys may be round or elliptical etc.

The device may comprise a plurality of location indicators. The location indicators may be arranged in a substantially triangular orientation. The arrangement of the location indicators may enable the software component to determine the position, size, layout and/or orientation of the device relative to the screen. The at least one location indicator may comprise a protrusion which projects from the body. The at least one location indicator (“leg”) may be arranged to space the rest or at least a portion of the body from the surface of the screen during use.

The device may comprise a shield arranged to hide or obscure operation of the electronic device from view by an observer. This may be called a privacy shield or guard. It may comprise a flange or raised portion, or a cover.

In some embodiments, the device may be arranged to slide or move relative to the screen in use. In other embodiments, the device may be arranged to maintain a position on the screen during use. For example, an adhesive, sticky or holding substance may be provided on a portion of the body, such as on the rear surface of the device, to prevent or impede movement of the device during use. This may be advantageous for users who are unable to use one or both hands.

Also in accordance with the disclosure there may be provided a data input assistance device comprising:
a body for placement on or adjacent to a touch screen of an electronic device, the body comprising:
at least one input zone arranged to facilitate or enable a user to operate an area of the touch screen by (e.g. direct) contact with the screen; and
a rear surface which, in use, faces and/or contacts a surface of the touchscreen and comprises:
   i) a layer, portion or coating of a material or substance which prohibits or impedes transmission of a signal or energy from the user's body to the surface of the touchscreen; and
   ii) at least one location indicator which enables or facilitates transmission of a signal or energy from the user's body to the surface of the touchscreen for communication, to a software component associated with the electronic device, the location of a portion of the input assistance device relative to the screen.

In such an embodiment, the rear surface may be substantially flat, level or uniform. It may be arranged such that, in use, it lies flat against the surface of the screen such that there is no gap between the rear surface of the body and the surface of the screen. The at least one location indicator may be embedded in the rear surface. The location indicator(s) may not space the device body from the surface of the screen. Features described above may also be applicable to this embodiment. As above, the input zone(s) may be openings, apertures or cut outs which expose the surface of the touchscreen and facilitate contact of the screen by the user.

Also in accordance with the disclosure there is provided a data input assistance system substantially as described herein. The system may comprise:

a data input assistance device in accordance with any embodiment as described above and/or hereafter; and

a software component arranged for execution on an electronic device having a touch screen, and arranged to provide a virtual input component/arrangement on the (screen of the) device at a location based on or influenced by the position of the at least one location indicator.

Also in accordance with the disclosure there is provided a corresponding method substantially as described herein. This may be referred to as a method for aiding the generation, tracking and/or relocation of a virtual input component guide, or a data input assistance method. It may comprise the steps of:

providing a software component operative or configured to provide a virtual input component at a location on a touch screen of an electronic device, the location being specified or influenced by a location indicator of a data input assistance device substantially as described above or hereafter.

The method may further comprise the steps of:

providing or using a data input assistance device substantially as described above or hereafter; and/or

bringing a/the data input assistance device substantially as described above or hereafter in proximity to a touch screen of the electronic device; and/or

operating a key of the virtual input component through at least one input zone of the data input assistance device; and/or

providing the virtual input component at a different location on the touch screen of the electronic device in response to movement of the input assistance device.

The disclosure also provides a computer-implemented system comprising:

an electronic device comprising a processor and associated memory;

a data input assistance device substantially as described above or hereafter.

Preferably, the memory includes executable instructions that, as a result of execution by the processor, causes the system to perform any embodiment of a computer-implemented method substantially as described above or hereafter.

The memory and/or processor may comprise or be associated with a portion of secure memory such as a Hardware Security Module (HSM) or Trusted Execution Environment (TEE).

The disclosure also provides a non-transitory computer-readable storage medium having stored thereon executable instructions that, as a result of being executed by a processor of a computer system, cause the computer system to at least perform an embodiment of a method substantially as described above or hereafter.

These and other aspects of the present disclosure will be apparent from and elucidated with reference to, the embodiment described herein. An embodiment of the present disclosure will now be described, by way of example only, and with reference to the accompany drawings, in which:

### BRIEF DESCRIPTION OF THE DRAWINGS

FIG. 1 shows a user-facing perspective of a device in accordance with an illustrative embodiment of an aspect of the disclosure.

FIG. 2 shows an illustrative embodiment of the present disclosure from two different perspectives—front and rear.

FIG. 3 shows the rear of a device in accordance with the embodiment of FIG. 1, and the relationship between the three contact points which contact the screen.

FIG. 4 shows the rear of a device in accordance with the embodiment of FIG. 1, including an illustration of how an offset peg or marker can be used to increase security in accordance with certain embodiments of the present disclosure.

FIG. 5 shows an alternative embodiment of the device of FIGS. 1 through 4, from a front and rear perspective.

FIG. 6 illustrates an example of a device in accordance with an embodiment of the disclosure, being used in conjunction with an electronic device in accordance with an embodiment of the system.

FIG. 7 shows the device in use with the electronic device of FIG. 6.

FIG. 8a and FIG. 8b show the device of FIGS. 1 through 7 in use with the electronic device of FIGS. 6 and 7. FIG. 8a shows a virtual keypad being displayed of the screen of the electronic device, and provided beneath the device; and FIG. 8b shows the same as FIG. 8a but without the virtual keypad being visible through the windows of the device.

FIG. 9 is a schematic diagram illustrates a computing environment in which various embodiments can be implemented.

### DESCRIPTION OF ILLUSTRATIVE EMBODIMENTS

The disclosure provides systems, methods and devices for enabling a user to input data into an electronic device. In the following disclosure, we provide an example use case wherein the invention is used to enter secret or sensitive data (which we may refer to as a “PIN”) for the purpose of verifying their identity before gaining access to a controlled resource e.g. bank account, building, vehicle etc. It should be noted that this use case is provided for illustration only and the invention is not limited with regard to this example. The data may be any form of data—numeric, alphanumeric, symbol, letter, picture etc.

Embodiments of the disclosure provide solutions that enable a virtual input mechanism/component/arrangement e.g. a virtual keypad, pin pad, keyboard etc (referred to hereafter as a “pin pad” or “virtual pin pad” for convenience) to be provided on a device and/or used in an improved manner. Typically, a software component which, may be called an application, on a phone will provide the pin pad on the screen at the same location and in the same orientation. Moreover, the location of the keypad will remain static during use. However, in some situations, it is desirable to be able to provide the keypad at a location dictated by or dependent upon some variable. This variable could be dependent upon the user, or supplied by the user. For example, a blind user cannot visually determine the location on the screen of a displayed keypad. Therefore, they do not know where to touch the screen in order to enter their data. Similarly, sighted users may not be able to determine the location of the keypad in visually challenging environments e.g. where there is poor lighting. In other situations, it may be desirable for security reasons to be able to alter the location and/or orientation of the keypad, so that malware on a compromised device cannot determine the user's input.

Another challenge is that the location and/or orientation of the keypad may need to change during use rather than remaining static. For example, a user with physical impairment may have difficulty keeping their hand in one location. Shaky or jerky motions may make input via a static keypad more challenging, and incorrect keys may be pressed as a result. This may render the data input process frustrating for the user, and also less efficient because it takes longer to correct the mistake and then enter the correct input. In other examples, environmental factors may make input difficult via a static keypad e.g. if the user is in a moving vehicle or performing an activity which makes it difficult for them to keep their finger over a static keypad. In such cases, it would be advantageous to allow the keypad to move around in the display zone as required or influenced by the user's needs.

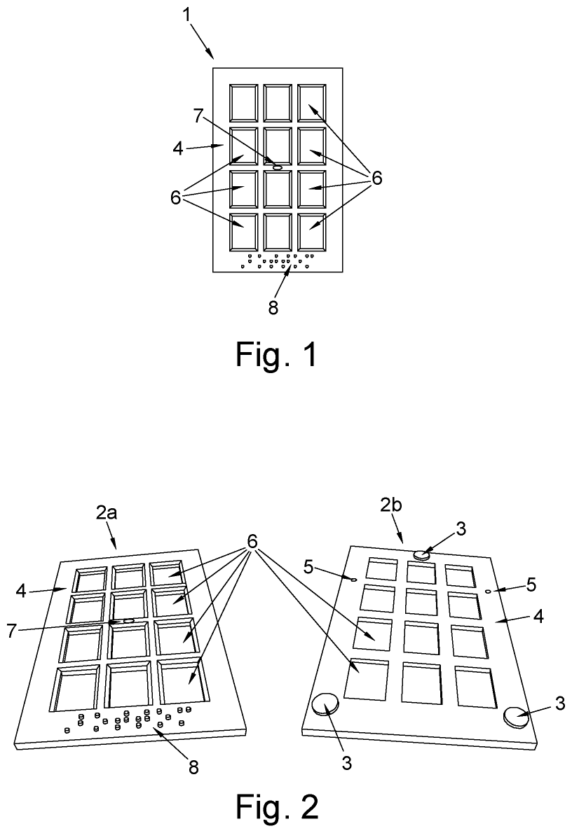

Turning to FIGS. 1 and 2, according to one aspect, the disclosure is embodied in a data input assistance/guidance device 1 which can be used in conjunction with a touch screen provided in, on or in association with an electronic device. FIG. 1 shows an illustrative device 1 in accordance with an embodiment of the present disclosure. FIG. 2 shows the disclosure 1 from two different perspectives—a front perspective 2a (FIG. 1 also shows the front perspective) and a back or rear perspective 2b. In use, the back perspective 2b is facing the touch screen of an electronic, computer-based device. This electronic device may be, for example, a mobile phone, a tablet computer, a laptop, a payment or card-reading terminal, ATM, payment system, vehicle/building security system etc. For the sake of convenience only, and to distinguish between the input device 1 and the electronic device 11, we will refer hereafter to the latter as a (mobile/smart) phone. Preferably, the touchscreen is a touch sensitive input device. Preferably, it comprises capacitive means for sensing contact by a user, and translating the signal(s) derived from that contact into data for input into memory associated with the electronic device. In use, the front of the device 1, 2a is facing or oriented towards a user who wishes to input one or more data items into the phone 11.

The phone 11 is arranged and configured to be able to read input data provided by a user via (i.e. “using” and/or “through”) the touch screen. The means for achieving this may comprise one or more hardware components e.g. sensors and/or one or more software components e.g. event listeners, software arranged to input a predetermined symbol (key indicia) into the phone's memory based on the user's contact with the screen 12.

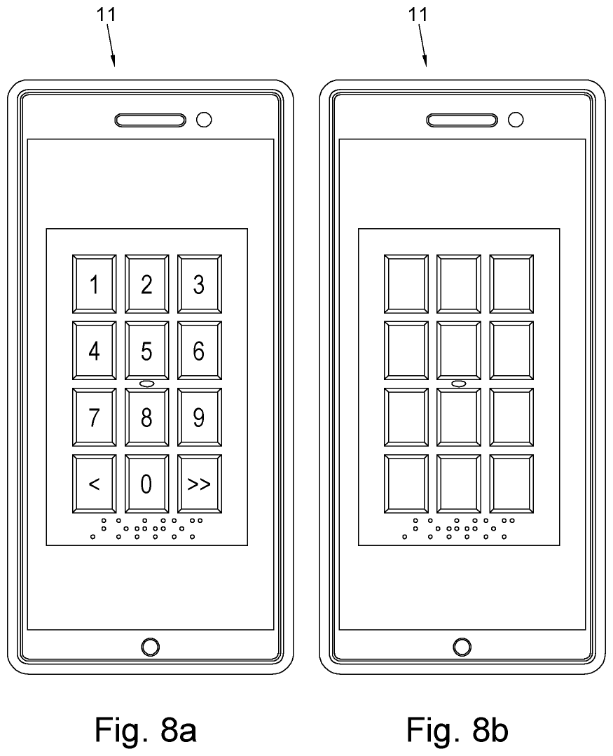

The phone comprises software operative to provide a virtual keypad within a display zone of the touch screen 12, as can be seen in FIG. 8a. It should be noted that the keypad may not actually be displayed in that it may be hidden, masked or obscured from view by a user, as shown in FIG. 8b. For example, part or all of the keypad may be presented on the screen in such a way that its colour matches or corresponds to the background colour of the screen, rendering the keypad invisible to the observer. In another embodiment, the keypad may be covered or superimposed by an image or other virtual object displayed in such a way that the observer cannot see the keypad. Alternatively, the keypad may not be output to the screen. In such cases, the code relating to generation/provision of the keypad does not include output instructions for displaying it, but simply includes instructions to generate they keypad with required the functionality and configuration. Thus, the keypad is provided, and is operational, but cannot be seen as per FIG. 8b.

The advantage of this is that it protects from “over the shoulder” surfing. For example, a user may not be aware that a third party is watching their actions and may thus be able to observe the potentially sensitive input data. This is especially a concern, for example, in respect of blind users. Therefore, the invention provides enhanced security and privacy.

The illustrative embodiment comprises an input device 1 comprising a body 4 which, in use, is placed such that a portion is adjacent to the screen. The body 4 is arranged such that it can slide or otherwise move relative to the surface of the screen. The body 4 is made of or comprises, at least in part, an electro conductive material, such as a plastic. The body 4 may be entirely made of this material, substantially made of it or only a minority or part thereof. However, enough electro conductive material is provided at the required location(s) to enable contact with the device to be communicated to the screen via the location indicators. This enables the software on the electronic device to know where the virtual keypad is to be provided within the display zone, as discussed in more detail below. In some embodiments the device 1 may be smaller than the screen of the electronic device and thus the device 1 may be moveable in relation to the screen. In other embodiments, the device 1 may be arranged to correspond (exactly or substantially) with the size of the screen and movement of the device 1 in use may be impaired or prohibited due to its size relative to the screen.

The body 4 is provided with location indicating means 3 for communicating the virtual keypad's desired position, size and/or orientation on the screen to the device. Thus, the location, size and/or orientation of where to generate the virtual keypad can be communicated by a location indication element 3 (leg) that is separate and distinct from the input zone(s) relative to position on the device body. Energy or a signal derived from the user's body is transmitted by the leg(s) to the screen for detection thereon, and then used in the generation of the virtual keypad.

In one embodiment, the entire body 4, including the legs, is made of or comprises a means for communicating a signal derived from the user's body to the touchscreen e.g. electroconductive plastic. In another embodiment, only part of the body 4 comprises such a means. In another, only one or more location indicators 3 may comprise such a means. The location indicators 3 may be raised or projecting portions which protrude or extend from the body 4 of the device. For convenience they are referred to herein as “legs”. In such an embodiment, the leg(s) 3 hold the rest of the body 4 of the device away from the screen so that the remainder of the body does not contact the screen directly. There is a gap provided between the surface of the screen and body of the device other than the legs, which touch the screen. This is advantageous, especially in embodiments where the entire body is made of conductive material, because it prevents other touches and handling of the device body by the user from being communicated to the touch screen as extraneous signals and thus obfuscating communication of the desired location to the keypad generation software. Such embodiments can thus be made of single layer of material, which reduces complexity of design, manufacturing time and costs, and allows for a lighter, easier and more efficient device that requires fewer resources for storage and transportation.

In an alternative embodiment, the rear surface of the device may be coated or provided with a non-conductive layer or substance which prohibits or impedes transmission of the signal from the user's body to the screen, other than at the legs. The front of the body may comprise a conductive substance or layer that transmits the signal or energy from the user during handling of the device in use to the legs, but the non-conductive portion of the rear face of the body prevents transmission to the screen elsewhere. In such embodiments, the location indicators do not need to be raised or protruding portions, but can be substantially flat or in-line with the rest of the rear surface of the device. They may be conductive elements which are embedded in the body of the device and coupled to the conductive top layer or face of the body such that the signal derived from the user's body can be communicated through the legs to the screen.

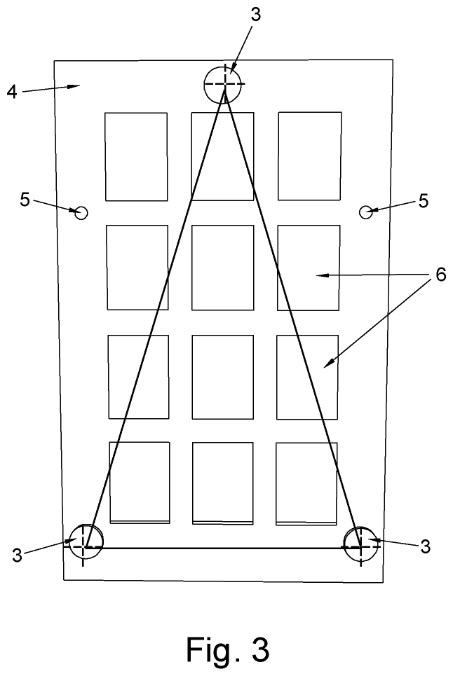

In a preferred embodiment, at least three legs 3 are provided on the rear 2b of the body, as shown in FIGS. 2, 3, 4 and 5. In the embodiment shown, they are arranged in a triangular configuration. This is advantageous because it enables the software on the electronic device to determine the size and orientation of the required virtual keypad that it will need to generate, and where it needs to position it within or relative to the display zone of the screen. For example, the single leg at the top of the triangle can be used to calculate where the top of the pin pad is to be provided. In other embodiments, however, only one leg may be provided, or two legs, or more than three. For example, if the input assistance device is to be of a fixed size then only two legs may be required. If the software on the phone, however, is required to dynamically re-size the virtual keypad then three or more legs are required. If the virtual keypad and/or input device 1 is/are circular, then only one leg may be provided.

The relative arrangement of the legs 3 on the body 4 may define an input detection zone on the screen. For example, the triangular portion of the screen covered by the triangle formed between the legs of the device shown in FIGS. 2 to 5 may be referred to as an input detection zone. Touches detected outside the input detection zone may be ignored by the software application. In other words, any touches falling outside this input detection zone are not interpreted as inputs.

In a preferred embodiment, the location indicators indicate the location of the device (and thus of the virtual pinpad) to the software using a signal derived from the user's body e.g. electrical energy. This provides a low cost and simple arrangements. In one or more alternative embodiments, the location indicators 3 are powered or energised in some way other than using electrical energy from the user's body. For example, the legs 3 can be powered using a battery. In all embodiments, however, the location indicators 3 are powered or energised in some way to enable the desired location, size, configuration and/or orientation of the virtual pin pad to be detected by the hardware/software on the phone as a result of contact between the screen and the location indicator(s) rather than by contact between the screen and the user. Thus, the user does not communicate data or signals relating to the size, configuration and/or orientation of the virtual input device directly to the software without it going via the location indicators 3. The conductive location indicators 3 transmit a signal that is detectable by the touchscreen and transmitted to the software to derive data relating to the virtual keypad. That data can then be used by the software to generate and or re-locate the virtual keypad in a particular location relative to the (display zone) of the touchscreen, and/or with a particular size and/or configuration.

The centre of the touch radius of a leg 3 can be used in the calculation of where to locate the virtual keypad relative to the display zone of the screen, and also its required size, dimensions and orientation.

Stabilizers 5 may be provided for improving stability of the body during use in certain embodiments. Examples are shown in FIGS. 2 to 5 as additional, supporting legs. As shown in the figures, the stabilising legs 5 are provided outside the triangle formed between the location indicating legs 3. This enables software on the phone to ignore any touchpoints outside the triangle. Thus, they may still be made of conductive material.

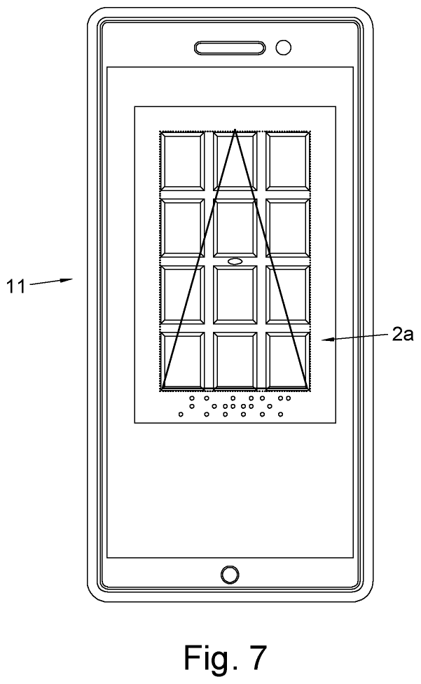

The body 4 of the input aid 1 is provided with one or more input zones 6 as shown in FIGS. 1 through 8. The input zone(s) 6 enable a user to operate an area of the touch screen through the device 1. In a preferred embodiment, this operation is achieved by permitting direct contact with the surface of the touch screen. The direct contact may be made with a portion of the user's body e.g. finger or some other pointing/selection device which enables the (electrical) signal derived from the user to be detected by the screen. The input zones 6 may be described as “windows” or “key locators” as they expose discrete portions of the screen and thus allow the user to select a particular key of the virtual pin pad through the device. Thus, the windows correspond to the location of keys within the virtual keypad. The windows 6 may be bevelled to accommodate larger fingers or pointing devices.

Preferably, the input zone(s) provide unfettered, unimpeded or uninterrupted access to the surface of the touch screen by the user so that the user's body or a suitably arranged (conductive) input device may make contact with the touchscreen surface without intervention or impediment by any part of the device, and/or without the need for translation or communication of the user's signal to the electronic device or touchscreen by a part of the device 1. Thus, the windows 6 may be cut outs, apertures or openings which have no barrier between the surface of the screen and the user. In other embodiments, perhaps for use in situations where dirt, moisture or other environmental factors are relevant, a membrane or some sort of material may be provided within the window to cover the screen. In such embodiments, the membrane would need to allow communication of the user's selection to the device, e.g. via conductive means.

The user is able to detect the location of the window(s) via non-visual means such as tactile feedback. For example, the user would be able to feel the edges of the windows shown in the figures. Additional features may be added to enhance detection e.g. the window(s) may be provided with a lip or ridge around at least part of the perimeter. In some embodiments, the body may be completely or substantially flat. The location and symbol of the key corresponding to a given window may be communicated in some way to the user when the user's touch is located within that area of the screen e.g. via vibration and/or sound. The sound may be communicated via wired/connected means (e.g. headphones that are plugged in to the electronic device) or wireless means (e.g. via Bluetooth, NFC, WiFi or other wireless connectivity).

FIGS. 1, 2, 5, 7 and 8a and 8b show a user reference guide or marker 7 which enables the user to locate a particular point or location on the input device 1. FIG. 8a shows this most readily. This feature is especially helpful for applications where visual observation of the device 1 is impaired or not possible e.g. by blind users or in poorly lit environments. In the figures, this is shown as a raised dot or nipple 7 which is located in the centre of the device 1. The user is able to locate this raised dot 7 by touch, and from this point is able to discern where the keys are located relative to that point. Thus, the user knows that if the dot 7 is provided under the window 6 which exposes the “5” key on a standard pin pad layout, to locate the “1” key they must move their finger up two windows and then one window to the left. The dot 7 thus functions as a marker to enable the user to locate a starting position on the device 1. In other embodiments, the marker 7 may be provided in combination with the configuration or provision of the input zone(s). For example, the “5” key may be provided as a square cut out in contrast to the shape of the other keys. This may provide a non-visual or tactile aid in locating a particular location on the body of the device.

The dot 7 is shown in the figures as a small raised bar below the “5” key. In other embodiments, however, the marker 7 could be provided elsewhere on the device, could take any shape, size orientation etc. In some embodiments, it may not be a raised portion, or provide a tactile means of location communication. For example, in some embodiments the software may detect the user's finger on a given location and communicate that via an audible means such as a beep or other sound.

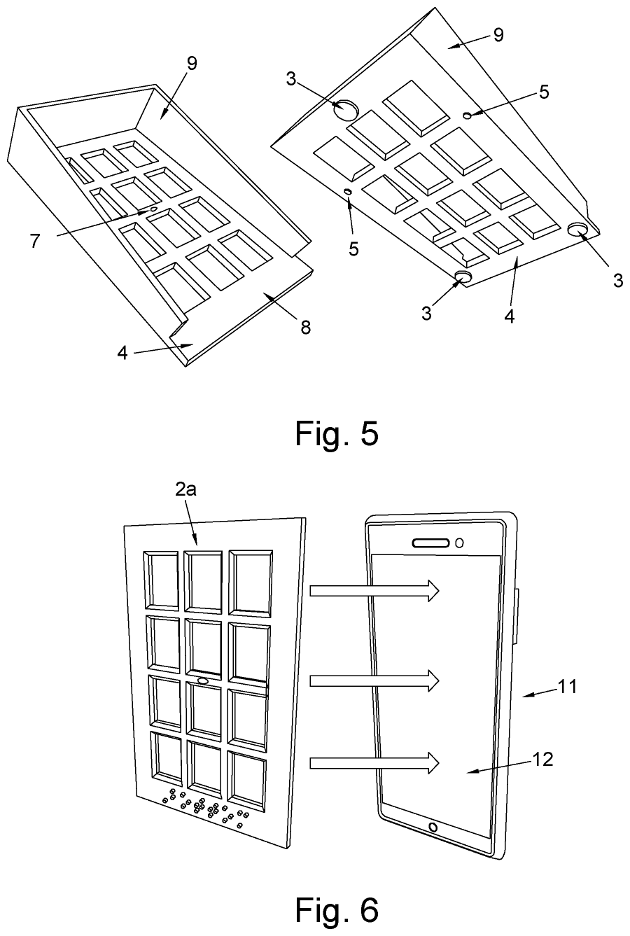

FIGS. 1, 2 and 5 show a message 8 provided on the body 4 of the device 1. In some embodiments, the message 8 may be provided on the front 2a of the body 4. In FIGS. 1 and 2, the message is provided in braille for communication to a blind user. In FIG. 5, the message 8 is a logo or branding information. However, the message may comprise instructions for use or other information.

FIG. 5 shows an embodiment which comprises a privacy shield 9 arranged to protect the user's keystrokes from observation. This feature provides enhanced security as the user's data input cannot be gleaned by unauthorised third parties. The privacy shield may be a raised guard or flange provided around at least part of the body 4.

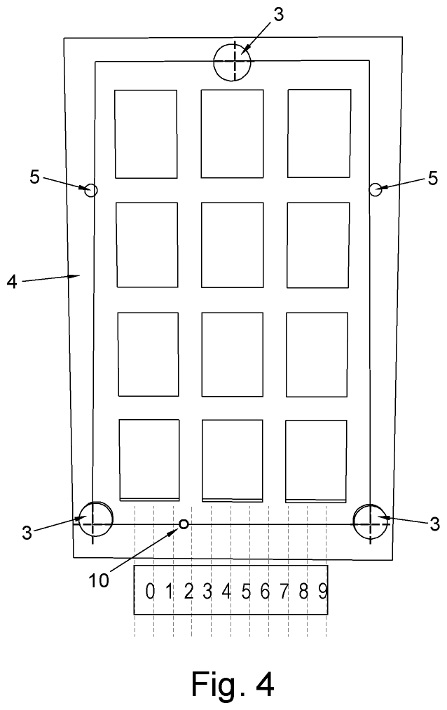

FIG. 4 shows an embodiment of the invention in which an offset marker 10 is provided on the body 4. The offset marker may adjust the user's input by a positive or negative specified value. In a preferred embodiment, it is proportioned, arranged and/or configured to contact the screen in use. This may be provided on the rear 2b of the device 1. The offset marker 10 (referred to hereafter as an “offset peg”) provides increased security and protection from over-the-shoulder-surfing and malware which may be present on a compromised phone. The offset marker 10 may be arranged to adjust or alter the user's input by a specified value. This adjustment may be performed before or after the input is read into memory e.g. by adjusting the symbol or indicia associated with the virtual key beneath or aligned with an input zone such that the input received into the electronic device is encoded. In this way, the offset marker may provide a mechanism for scrambling or altering the configuration/layout of keys on the virtual keypad relative to a standard keypad. It may provide a shift-wise rearrangement of the keys.

As shown in FIG. 4, the location of the offset peg 10 relative to another point on the body 4—such as the centre point of a leg or the body 4—can be used by software on the phone 11 to determine an offset value. As with the legs 3, the offset peg 10 is formed in such a manner as to enable communication of its location to the device e.g. by comprising an electro conductive material. When using an embodiment which comprises this feature, the user may apply a pre-determined offset value to their inputs. For example, if the user's PIN is 1234 and their offset value is 2, the user would enter their PIN as 3456. Thus, the offset enables an encoded version of the input to be calculated prior to entry by the user. The software can then decode the user's input by subtracting the offset value to arrive back at the actual value. In another example, the user may enter their real input without encoding it with an offset value, but the software may then apply the offset value indicated by the offset peg to provide an encoded version of the supplied input. In other embodiments, an offset value may be applied by the user and also by the software. The offset value used by the user may be the same or a different value compared to that used by the phone's software. More than one offset peg 10 may be provided.

Additionally, or alternatively, other techniques may be used to adjust or scramble the configuration of the keys on the virtual keyboard or influence the interpretation of the user's input by the software into the electronic device. These techniques may include, for example, the use of biometric data derived from the user to influence the virtual keypad configuration, or random number generation. The software that generates the underlying virtual keypad may utilise any known method for scrambling a keypad layout, including the techniques disclosed in WO2014/013252, WO2016/189325 the contents of which are incorporated herein in their entirety.

Example: An Illustrative Embodiment in Use

In use, the input device 1 is arranged to communicate with hardware and at least one software component provided on the user's mobile phone 11. The user may download and install the software onto the phone prior 11 to use. The software is arranged to interpret the signals from the contact points on the device 1 as parameters to be used in the generation, placement and/or display of the virtual keypad. When the user wishes to enter data in accordance with the present invention, the user may execute the software component e.g. by selecting an icon on their phone 11.

Upon execution, the software application “knows” that data is to be entered and a virtual keypad is to be generated and provided in the correct location as indicated by the user via the device body. The user places the (electroconductive) input device 1 against the screen such that the legs 3 and stabilizers 5 are in contact with the display zone 12 of the phone. The electrical signals derived from the user's body are detected by the screen via the legs. The single leg 3 at the top of the body 4, 2b indicates to the software where it needs to place the top of the virtual keypad relative to the display zone, and the orientation of the virtual keypad. The configuration and relative position of the three legs 3 provide the necessary information relating to the desired size of the pin pad. The software uses this information to generate the virtual keypad. This may be achieved, at least in part, using a procedure call supplied with the phone. Thus, in some embodiments, the virtual keypad generation may be performed by a subroutine contained in the library supplied by the manufacturer of an electronic device 11 and called by a software component downloaded and installed by a user. In other embodiments, the entire method(s) in accordance with the invention may be performed by proprietary software downloaded and installed onto the device. In yet other embodiments, the necessary software may be supplied with the device 11, and thus not require any download or installation by a user.

In some embodiments, the software causes the screen 12 to go blank or turn a solid colour e.g. black in order to prevent the virtual keypad from being observed. As above, in other embodiments, the virtual keypad may not be displayed at all or may be displayed so as to blend with the background of the screen and thus be invisible to an observer. This is shown in FIG. 8b. As the present inventions provides a data entry means which does not require visual capabilities on behalf of the user, this security feature does not impair the ease of use of the invention.

The software then provides the virtual keypad beneath the device 1. Thus, in use, the input device 1 functions as a removeable and re-positional overlay that tells the software how and where the keypad is to be provided and track it if it moves relative to the screen. The keypad is drawn to scale under the windows 6 of the device 1 as shown in FIG. 8a. If the device 1 is moved across the screen, the software will track this and refresh the screen at an appropriate refresh rate e.g. 50 fps.

The user locates the raised dot 7 in the centre of the input device 1 thus knowing where the “5” key is located and, by reference, the other keys. The user moves his/her finger to the window 6 for the first digit they wish to enter, making contact with the surface of the screen through the desired window 6 for a predetermined length of time e.g. 2 seconds. This predetermined length of time prevents accidental touches being interpreted as intended keystrokes as the user moves their finger around the windows. In embodiments which utilise a Touch3D device the user alters the pressure of their touch to indicate data input. To confirm a successful entry of the input, the phone may beep, vibrate or otherwise indicate entry to the user. The user then moves to the desired window 6 for the key of the next digit they wish to enter. This is repeated for all desired characters that the user wishes to enter. The software stores each input and constructs a string which represents the user's collective keystrokes. This could be, for example, a PIN or password or other sensitive or secret data. Any accidental keystrokes may be indicated to the software via a predetermined signal such as pressing a “delete” key. This may be performed in a secure portion of memory or secure environment. The string may be sent to a location and used in an authentication process for validation of the user's identity.

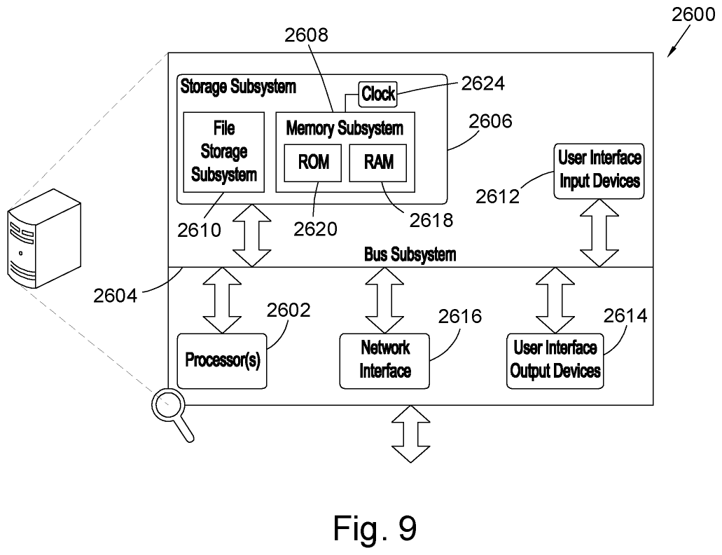

Turning now to FIG. 9, there is provided an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as a data server, a web server, a portable computing device, a personal computer, or any electronic computing device. As shown in FIG. 9, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate. The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 9 is intended only as a specific example for purposes of illustrating the preferred embodiment of the device. Many other configurations having more or fewer components than the system depicted in FIG. 9 are possible.

Terminology

Herein the terms “keypad”, “pin pad” and “keyboard” may be used interchangeably and synonymously, and all of these terms are intended to cover a virtual input device, component or mechanism for entering data into a computer-based resource such as, nut not limited to, a laptop, personal computer, mobile phone, tablet or any other form of processor-based computing device. The computer-based resource may comprise an electronic device and/or a software application running on such a device. The terms “virtual keypad/keyboard/pin pad” are intended to include a software-implemented version or representation which models the functionality of a mechanical keypad/keyboard, as known in the art. The virtual keypad/keyboard/pin pad provides keys, each associated with a symbol or indicia such that operation of a key by a user causes the relevant symbol associated with the selected key to be entered into (potentially secure) memory within the device for use by a software application.

The computer-based resource may be any type of electronic, processor-based device comprising an operating system. This includes but is not limited to: servers, mobile devices, personal computers, PoS, payment entry/processing systems and devices, card reading devices, dedicated computing arrangements e.g. ATM machines and networks comprising any combination of such devices. The computer-based resource may comprise at least one software application arranged for execution on a processor associated with the device. The computer-based resource may be arranged and/or operative to generate a virtual input device.

The terms “authentication”, “verification” and “validation” are used interchangeably herein. The term “virtual” is used interchangeably herein with “electronic” in relation to keypad/pinpad/keyboard.

The term “configuration” when used in relation to a keypad, whether virtual or physical, may be used herein to include the layout and/or arrangement of keys.

The term “data” as used herein can be interpreted as meaning any signal that is capable of being entered as input into an electronic computing device. The input/data could be a signal interpreted by the device as any type of data, including (for example) but not limited to a portion of text, a character, a string, an integer or floating point value, a symbol, an instruction, a procedure/function/method call, a representation of a static or moving image etc.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A data input assistance device comprising:
a body for placement adjacent to a touch screen of an electronic device;
at least one input zone provided in or on the body and arranged to facilitate or enable a user to operate an area of the touch screen by contact with the screen; and
at least one location indicator arranged to communicate to a software component associated with the electronic device, the location of a portion of the input assistance device relative to the touch screen.

2. A device according to claim 1, wherein the area of the touch screen is, provides and/or functions as a key of a virtual input component, preferably wherein the virtual input component is a virtual keypad, a virtual pinpad or a virtual keyboard.

3. A device according to claim, wherein at least a portion of the body, at least one location indicator and/or at least one input zone comprises an electrically-conductive material.

4. A device according to claim 1, wherein the at least one input zone:
i) comprises at least one aperture arranged to expose the screen and enable contact with the screen by a user; and/or
ii) comprises an area which is arranged to conduct an electrical signal to the touch screen for detection by a sensor; and or
iii) does not comprise a barrier between the surface of the touch screen and the user; and/or
iv) is spaced from the surface of the touch screen.

5. A device according to claim 1, wherein the body comprises:
i) at least one layer of a material through which a signal or energy derived from a user's body can be transmitted or conducted to the touch screen, and/or
ii) a reference marker for tactile or audible communication of a location on the body to a user via touch or sound; and/or
iii) a rear surface which:
in use is spaced from the surface of the touch screen, by the at least one location indicator; and/or
in use faces the surface of the touch screen; and/or
comprises a layer, portion or coating of a material or substance which prohibits or impedes transmission of a signal from the user's body to the surface of the touch screen.

6. A device according to claim 5, wherein the reference marker comprises a raised, indented or grooved portion relative to the body, and/or an audible signal upon detection of contact by a user.

7. A device according to claim 1, wherein the device:
i) is not fixed, adhered or maintained in position relative to the electronic device during or before or after use; and/or
ii) comprises a plurality of location indicators; and/or
iii) comprises an offset marker arranged to adjust or alter a data value received into/by, or interpreted as input by, the software component by a specified value.

8. A device according to claim 1, wherein the at least one location indicator:
i) comprises a protrusion which projects from the body; and/or
ii) is arranged to hold or position the body or a portion thereof away from, spaced from or adjacent to the touch screen; and/or
iii) is provided on the body separately from the at least one input zone.

9. A device according to claim 1, wherein the body further comprises a shield arranged to hide or obscure operation of the electronic device from view by an observer.

10. A data input assistance device comprising:
a body for placement adjacent to a touch screen of an electronic device, the body comprising at least one input zone and a rear surface;
wherein the at least one input zone is arranged to facilitate or enable a user to operate an area of the touch screen by transmission of a signal or energy from the user's body as a result of contact with the touch screen; and
wherein the rear surface is arrange to face a surface of the touch screen in use and comprises:
i) a layer, portion or coating of a material or substance which prohibits or impedes transmission of a signal or energy from the user's body to the surface of the touch screen; and
ii) at least one location indicator which enables or facilitates transmission of a signal or energy from the user's body to the surface of the touch screen for communication, to a software component associated with the electronic device, the location of a portion of the input assistance device relative to the touch screen.

11. A data input assistance system comprising:
a data input assistance device according to claim 1; and
a software component arranged for execution on an electronic device associated with a touch screen, wherein the software component is arranged to provide a virtual input component on the device at a location based on the position of the location indicator.

12. A data input assistance method comprising:
providing a software component operative to provide a virtual input component at a location on a touch screen of and/or associated with an electronic device, the location being specified or influenced by a location indicator of a data input assistance device of claim 1.

13. A method according to claim 12, further comprising:
providing the data input assistance device of claim 1; and/or
bringing the data input assistance device of claim 1 in proximity to the touch screen of the electronic device; and/or
operating a key of the virtual input component through at least one input zone of the data input assistance device of claim 1; and/or
providing the virtual input component at a different location on the touch screen of the electronic device in response to movement of the data input assistance device of claim 1.

14. A computer-implemented system comprising:
an electronic device comprising a processor and associated memory and associated touch screen; and
a data input assistance device according to claim 1.

15. A system according to claim 14, wherein the memory includes executable instructions that, as a result of execution by the processor, causes the system to provide a virtual input component at a location on the touch screen, the location being specified or influenced by a location indicator of the data input assistance device according to claim 1.

16. A non-transitory computer-readable storage medium having stored thereon executable instructions that, as a result of being executed by a processor of a computer system, cause the computer system to provide a virtual input component at a location on a touch screen associated with an electronic device, the location being specified or influenced by a location indicator of a data input assistance device according to claim 1.
